(19) United States
(12) Patent Application Publication
(10) Pub. No.: US 2002/0179538 A1
(43) Pub. Date: Dec. 5, 2002

(54) Polyamphoteric polymers for raw water treatment

(76) Inventors: Brian S. Johnson, Warrenville, IL (US); Christine A. Staples, Lakewood, CO (US); Michael L. Braden, Sugar Land, TX (US)

Correspondence Address: Margaret Meta Brumm, Patent & Licensing Department, ONDEO Nalco Company, ONDEO Nalco Center, Naperville, IL, 60563-1198, US

(21) Appl. No.: 09/815,790

(22) Filed: Mar. 23, 2001

(51) Int. Cl. C02F 1/56

(52) U.S. Cl. 210/727; 210/734; 210/928

(57) ABSTRACT

Methods for treating raw water using polyamphoteric polymer coagulants are provided. The amphoteric polymers can be added to the raw water separately or together with metal salt based coagulants. The amphoteric polymer coagulants can be added to the raw water, before and after the clarification unit operation, prior to filtration. The methods of the present invention can be used in a variety of different raw water treatment applications, such as raw water used in municipal drinking water treatment facilities.

### FIELD OF THE INVENTION

The present invention relates to methods for treating raw water. More specifically, the present invention relates to methods for treating raw water using polyamphoteric polymers; optionally in combination with metal salt coagulants.

### BACKGROUND OF THE INVENTION

Water treatment processes employ a variety of different treatment agents to treat water for a number of different applications, such as industrial, commercial, residential, recreational and the like. The water for treatment can include wastewater and raw water. Wastewater essentially includes water derived during and/or after use. For example, wastewater includes industrial wastewater which result from industrial processes, such as those relating to agricultural, paper, and food processes. After or during use, the wastewater may contain an unacceptable level of contaminants, such as, solids, metals, organics, acids, bases and other like contaminants. To treat the wastewater, a number of different coagulants, flocculants and other water treatment agents can be effectively used.

Commonly known and used wastewater treatment agents include metal salts and organic polymers, such as polyamines, epichlorohydrin-dimethylamine (“Epi-DMA”), ethylene dichloride-ammonia (“EDC-ammonia”), melamine formaldehyde and polydiallylmethyl ammonium chloride (“polyDADMAC”). The metal salts and organic polymers can be added separately or in any combination thereof to treat the wastewater.

Raw water generally does not contain the same unacceptable level of contamination as compared to that of a wastewater source. Raw water typically includes industrial and natural raw water. Industrial raw water can include a water source prior to its use with respect to an industrial process. This type of raw water source can include, for example, recycled industrial water, that is, wastewater that has been treated and recycled for eventual process use. Natural raw water can be derived from surface waters, streams, lakes, rivers, wells, groundwater and other natural water sources. The raw water can be used for a variety of different applications, such as those industrial process applications relating to agriculture, paper, food and drinking water treatment applications.

Raw water can be treated via sedimentation, direct filtration or combinations thereof depending on how the treated raw water will be used and the quality of said water. For example, a drinking water treatment facility may use any number and combination of sedimentation and filtration applications to ensure that the treated raw water meets regulatory drinking water standards. In general, the raw water source for use in drinking water treatment applications is typically derived from natural raw water sources.

Conventional sedimentation applications use treating agents that include organic polymers, metal salts and combinations thereof. The organic polymer coagulants commonly used are polyamines, Epi-DMA, EDC-ammonia, melamine formaldehyde and polyDADMAC. Direct filtration applications often use only organic polymer coagulants.

However, the use of commonly known organic polymer coagulants, such as Epi-DMA, alone or in combination with metal salt coagulants, to treat raw water can be costly. Accordingly, there exists a continuing need to provide improved methods for treating raw water that use coagulants that are less costly and that can be used for a wide variety of raw water treatment applications.

### SUMMARY OF THE INVENTION

This invention is a method of treating raw water comprising the step of adding an amphoteric polymer coagulant and optionally at least one metal salt coagulant to the raw water.

### DESCRIPTION OF THE INVENTION

Throughout this patent application, the following terms have the indicated abbreviations and meanings:

“Nephelometric Turbidity Units” is abbreviated NTUs. The NTU measurement indicates the level of turbidity in the raw water sample after a certain period of time after adding the polyamphoteric polymer coagulant and the metal salt based coagulant to the same. This method of measuring turbidity is based on a comparison of the intensity of light scattered by the sample under defined conditions with the intensity of light scattered by a standard reference suspension under the same conditions. The higher the intensity of scattered light, the higher the turbidity. Formazin polymer is used as the primary standard reference suspension. The turbidity of a specified concentration of formazin suspension is defined as 4000 NTU.

“Parts Per Million” is abbreviated ppm. Throughout this patent application, ppm refers to ppm of the product, not ppm of the active material within the liquid product.

“Raw Water” is meant to include industrial raw water, natural raw water or other like raw water sources. Industrial raw water is generally understood to include any water source prior to its use with respect to an industrial process. This type of raw water source can include, for example, recycled industrial water, that is, wastewater that has been treated and recycled for subsequent use. Natural raw water is generally understood to include any water source derived from a natural source of water, such as surface waters, rivers, streams, lakes, groundwater, aquifers and other like natural water sources.

“Reduced Specific Viscosity” is abbreviated RSV. RSV is an indication of the relative polymer chain length and average molecular weight. The RSV is measured at a given polymer concentration and temperature and calculated as follows:

$$R S V = \frac{[ ( η / {η}_{o} ) - 1 ]}{c}$$

η=viscosity of polymer solution

η=viscosity of solvent at the same temperature

c=concentration of polymer in solution.

For this equation the units of concentration “c” are (grams/100 ml or g/deciliter). Therefore, the units of RSV are dl/g. The solvent used was 1.0 molar aqueous sodium nitrate solution. The polymer concentration in this solvent was 0.045 g/dl. The RSV was measured at 30° C. unless otherwise indicated. The viscosities η and ηₒ were measured using a Cannon Ubbelohde semimicro dilution viscometer, size 75. The viscometer is mounted in a perfectly vertical position in a constant temperature bath adjusted to 30±0.02° C. The error inherent in the calculation of RSV is about 2 dl/gram. Within a series of polymer homologs, which are substantially linear, and well-solvated, polymers with similar RSV's have similar molecular weights according to Paul J. Flory, in “Principles of Polymer Chemistry”, Cornell University Press, Ithaca, N.Y., © 1953, Chapter VII, “Determination of Molecular Weights”, pp. 266-316.

“Intrinsic Viscosity” is abbreviated IV. IV is RSV extrapolated to the limit of infinite dilution, infinite dilution being when the concentration of polymer is equal to zero.

The present invention relates to methods for treating raw water. More specifically, the present invention relates to methods of treating raw water that use amphoteric polymer coagulants, separately or in combination with metal salt coagulants. It has been discovered that polyamphoteric polymer coagulants can be effectively used to treat raw water at lower concentrations than commonly used organic polymer coagulants, such as polyDADMAC. Further, the methods of the present invention which use amphoteric polymers can be effectively applied to a greater range of raw water treatment applications as compared to commonly used organic polymer coagulants, such as Epi-DMA. The use of these types of organic polymers alone or in combination with metal salts for treating raw water, particularly with respect to drinking water treatment applications, is restricted based on the extent to which the use of such coagulants is regulated.

At the outset, it is important to note the distinction between raw water and wastewater treatment. The most critical distinction between wastewater and raw water is in the level of contaminants. Wastewater typically contains a much higher level of contaminants then does raw water. Additionally, contaminants in unprocessed “natural” raw waters will be watershed dependent while contaminants in industrial processed wastewater are present depending upon the specific type of industrial process.

Raw water can be used for a variety of different water-based processes. These applications can include but are not limited to municipal, industrial, recreational, residential, commercial and other like water-based processes. Municipal applications of raw water include, for example, raw water processing at a drinking water treatment facility. The raw water is processed to produce a source of drinking water. In this application, the raw water source for processing or treatment is typically a natural raw water source, such as those derived from lakes, streams, rivers, surface waters, wells and groundwater or other like water source.

Wastewater, on the other hand, is generally understood to include water derived during and/or subsequent to its use. Wastewater can result from a number of different applications, such as industrial, commercial, recreational, residential and other like applications. For example, industrial wastewater results from industrial processes that use water for a variety of different applications, such as cooling, extraction, heating, mixing, transporting or other like applications. During and after such use, the wastewater may contain a gross level of contamination derived from the process application. As applied to industrial processes, wastewater can include a variety of different contaminants, such as solids, metals, organics, acids, bases and other like contaminants.

Wastewater, in contrast to raw water, is generally understood to include a higher level of contaminants (gross level) as compared to that of a raw water source, such as recycled industrial water and a natural water source. This distinction between raw water and wastewater is important, particularly when evaluating how each of these water sources is to be treated or processed. Depending on the level of contamination in the water, different treatment options and considerations are typically evaluated. The effectiveness of treating water by employing a water treating agent, such as a coagulant, flocculent or other like agent, may depend not only on the type of contaminant to be treated but also the amount of contaminant and how much this amount is required to be reduced.

The present invention provides a method of treating raw water that includes the step of adding an amphoteric polymer coagulant, alone or in combination with a metal salt based coagulant, to the raw water. The present invention may include any suitable amphoteric polymer. Preferably, the present invention provides an amphoteric polymer that is a copolymer derived from the reaction between acrylic acid and a monomer component. The monomer component may include any suitable monomer. Preferably, the monomer component includes an amine acrylate. More preferably, the monomer component may include amine acrylates, such as dimethylaminoethyl acrylate (DMAEA), dimethylaminoethyl acrylate methyl chloride quat (DMAEA.MCQ), dimethylaminoethyl acrylate benzyl chloride quat (DMAEA.BCQ), dimethylaminoethyl methacrylate (DMAEM), dimethylaminoethyl methacrylate methyl chloride quat (DMAEM.MCQ), dimethylaminoethyl methacrylate benzyl chloride quat (DMAEM.BCQ), dimethylaminoethyl methacrylate sulfuric acid salt (DMAEM.H₂SO₄), N-((3-dimethylamino)-propyl)methacrylamide (DMAPMA), 3-(methacryloylamino-propyl)trimethyl ammonium chloride (MAPTAC) and other like amine acrylates.

The amphoteric polymer includes a molar ratio of the monomer component to acrylic acid that ranges from about 99:1 to about 1:99. Preferably, the molar ratio ranges from about 90:10 to about 50:50. More preferably, it ranges from about 90:10 to about 70:30.

The IV of the amphoteric polymers used in the method of the instant claimed invention may range from about 0.8 deciliters/gram (“dl/g”) to about 3.0 dl/g in 1 molar sodium nitrate.

The amphoteric polymers useful in the method of the present invention are water-soluble. It is understood that these polymers are supplied in liquid form, with the polymer portion of the liquid actually making up only about 25% of the total liquid. The synthesis of amphoteric polymers of the present invention is described in U.S. Pat. No. 5,552,498 (the '498 patent), herein incorporated by reference.

The metal salt based coagulants of the present invention may include any suitable metal salt based coagulant that is typically used to treat water. The metal salt based coagulant can include, but is not limited to, aluminum sulfates, polyaluminum chlorides, including aluminum chlorohydrate, ferric salts, ferrous salts, and other similar metal salt based coagulants, and mixtures thereof.

Unlike with other polyelectrolyte coagulants, such as Epi-DMA and polyDADMAC which can be blended with metal salt coagulants such as alum, polyaluminum chlorides, ferric salts and the like as single product coagulant blends; the polyamphoteric polymer coagulants used in the instant claimed invention should not be blended with the metal salt coagulant prior to being added to the raw water. This is because when polyamphoteric polymer coagulants are blended with metal salt coagulants undesirable precipitation/gelling occurs. This precipitation/gelling is usually reversible when the precipitates/gels are diluted with enough raw water; nevertheless, it is not recommended that the polyamphoteric salt coagulant and the metal salt coagulant be pre-blended prior to addition to the raw water.

It is likely that stabilizers exist that could provide for a stable mixture of polyamphoteric polymer coagulant and metal salt coagulants, however, as of the filing date of this patent application, those stabilizers have not yet been identified.

The method of this invention is accomplished by adding polyamphoteric polymer coagulant and optionally a metal salt coagulant at some desirable or convenient point sufficient to allow for coagulation. If a metal salt coagulant is also used, dosing is typically done with separate feed systems. It can also be done with single feed system provided that a water flushing takes place of the feed pipe between dosing of the polyamphoteric polymer coagulant and the metal salt coagulant.

Preferably, the polyamphoteric and the metal salt coagulants are added at nearly the same, but not exact spot. One preferred method of addition is for one of the two coagulants to be dripped into a raw water stream and the other coagulant to be added to said raw water stream within about one foot or vice versa. Or the second coagulant could be added even further downstream, as long as there is sufficient time to allow for coagulation.

A possible alternative to separate feed points is that mixing could briefly occur if there is only one available feedpoint and for convenience it is easier that both coagulants be added together. In such situations the mix zone must be very close to the point of contact with the raw water. For purposes of this application, there should be no more than 10 seconds of contact time between the polyamphoteric polymer coagulant and the metal salt coagulant before they are added to said raw water. It is preferable that one or both coagulants are prediluted to prevent said gelling or precipitation. Dilution can be accomplished with finished water, tap water, mill water or even untreated raw water as long as dosing is done immediately after mixing.

The polyamphoteric polymer coagulants, alone or in combination with metal salt based coagulants, can be used to effectively treat raw water in a number of different treatment applications, such as those relating to municipal, industrial, residential, commercial, recreational and other like applications. For example, the raw water treatment methods of the present application can be used to treat raw water at municipal drinking water treatment facilities. As previously discussed, the source of raw water that is to be processed at drinking water treatment facilities is typically derived from natural raw water sources, such as those water bodies which include surface waters, lakes, streams, rivers, wells, groundwater and the like.

In general, drinking water treatment facilities employ a variety of different chemical engineering unit operations to ensure that the end product, that is the treated raw water, meets regulatory drinking water standards. For example, drinking water treatment facilities can include any number of sedimentation unit operations, filtration unit operations and combinations thereof to ensure that the treated raw water is a potable source of drinking water.

In an embodiment, the present invention provides a raw water treatment method that employs an amphoteric polymer, alone or in combination with a metal salt based coagulant, to treat raw water. The present invention may include any number and variety of suitable amphoteric polymer coagulants and optionally metal salt based coagulants that can be used to effectively treat raw water. Preferably, the polyamphoteric polymer coagulants and metal salt based coagulants include those types as previously discussed.

In an embodiment, the present invention provides a raw water treatment method that uses polyamphoteric polymer coagulants and metal salt based coagulants during a sedimentation unit operation for clarifying the raw water. After sedimentation is complete, the present invention further provides for filtering the clarified raw water.

In an embodiment, the present invention provides raw water treatment methods that only employ polyamphoteric polymer coagulants. Upon adding these coagulants to the raw water, the raw water is clarified via a sedimentation unit operation and then the clarified water is typically filtered. The addition of polyamphoteric polymer coagulants prior to and/or during direct filtration can be used effectively to treat the raw water.

In this regard, this type of application associated with polyamphoteric polymers may be used as a “coagulation” agent, aka “filter aid”, to treat the raw water prior to filtration. Alternatively, the “coagulation” application of polyamphoteric polymers can be employed in combination with a number of sedimentation applications. Preferably, the “coagulation” application occurs after the sedimentation/clarification unit operation and is used to further treat the raw water prior to filtration.

The polyamphoteric polymer coagulants and metal salt based coagulants can be added to the raw water in any suitable amount such that the raw water is effectively treated, for example, by reducing turbidity, color and other like clarification parameters.

In an embodiment, the polyamphoteric polymer is added to the raw water in an amount of at least about 0.25 ppm. Preferably, the amphoteric polymer is added to the raw water in an amount ranging from greater than about 0.25 ppm to about 6 ppm. More preferably, the amphoteric polymers of the present invention are added in an amount ranging from about 0.5 ppm to about 5 ppm. The added amount of the amphoteric polymer may vary depending on what type of treatment application is used and the raw water in question. The upper limit is generally limited only to the extent that the treatment parameters, such as turbidity, remain relatively constant with increasing amounts of polyamphoteric polymer coagulants. For purposes of having a practical limitation the upper limit of polyamphoteric polymer coagulant should be no more than about 6 ppm. It is of course, understood, that more polyamphoteric polymer coagulant can be used, but using more does not necessarily result in better effects and using more than is required is costly and wasteful. It is understood that with polyelectrolytes, one of the recognized features of overdosing is that after a certain point turbidity will increase based on just too much polyamphoteric polymer coagulant being present.

In an embodiment, the metal salt based coagulant is added to the raw water in an amount of at least about 23 ppm preferably at least about 30 ppm, more preferably, at least about 45 ppm. For purposes of having a practical limitation the upper limit of metal salt based coagulant should be no more than about 1000 ppm. It is of course, understood, that more metal salt based coagulant can be used, but using more does not result in better effects and using more than is required is costly and wasteful. Also, the upper limit of the amount of metal salt based coagulant is also generally limited to the extent that the raw water treatment parameter, such as turbidity, remains relatively constant with increasing amounts of the metal salt based coagulant.

The following examples are intended to be illustrative of the present invention and to teach one of ordinary skill how to make and use the invention. These examples are not intended to limit the invention or its protection in any way.

### EXAMPLE 1

Jar samples of a surface water source used at a working Paper Mill in the Southern United States were obtained and employed for this test example. To each of the jar samples of surface water, an amount of a polyamphoteric polymer coagulant and a metal salt based coagulant were added. The polyamphoteric polymer included a copolymer of 70 mole percent DMAEA.MCQ/30 mole percent acrylic acid. The copolymer of Example 1 (Nalco® N-2490, available from Nalco Chemical Company, One Nalco Center, Naperville, Ill. 60563, (630) 305-1000) was prepared as described in the previously incorporated by reference '498 patent. The percent solids of the copolymer was about 25%.

The metal salt based coagulant of Example 1 was a commercially available source of aluminum sulfate with an aluminum sulfate content of approximately 48 weight % Al₂(SO₄)₃.xH₂O, with x varying from 14 to 18 depending on how the product is made.

The amount of copolymer polyamphoteric polymer coagulant varied with respect to each of the jar samples, as indicated below in Table I. The amount of aluminum sulfate remained constant in each of the jar samples in an amount of 30 ppm. Example 1 was performed to demonstrate the effect that the amount of polyamphoteric polymer coagulant has on the clarity of raw water as measured in NTUs.

### RESULT 1

TABLE I

| Amount of Polyamphoteric | Amount of Aluminum Sulfate | Turbidity |
|---|---|---|
| Polymer (ppm) | (ppm) | (NTU) |
| 1 | 30 | 9.5 |
| 2 | 30 | 6.0 |
| 3 | 30 | 4.6 |
| 4 | 30 | 4.2 |
| 6 | 30 | 5.0 |

As indicated in Table I, the turbidity of the surface water sample from Example 1 was effectively reduced by adding increasing amounts of the polyamphoteric polymer coagulant of Example 1. The most significant reduction in turbidity occurred between 1 ppm to about 3 ppm of the polyamphoteric polymer coagulant of Example 1. At about 3 ppm of the polyamphoteric polymer coagulant, the turbidity essentially remained constant as increasing amounts of the polyamphoteric polymer coagulant were added to the surface water sample. These results indicate that the present invention can be effectively used to treat raw water without the additional use of commonly known organic polymers, such as Epi-DMA coagulants.

### EXAMPLE 2

Jar samples of a raw water source, namely fresh water, from a Drinking Water Treatment Plant in the Western United States were obtained and tested in Example 2. As indicated below in Table IIA and Table IIB, the effects of adding an amphoteric polymer coagulant in conjunction with a metal-base coagulant to a raw water sample (Table IIA) were evaluated in comparison to the addition of a commonly used organic polymer coagulant, namely, polyDADMAC, and a metal salt based coagulant to a raw water sample (Table IIB). The amphoteric polymer coagulant was the same type of amphoteric polymer coagulant used in Example 1. To a number of jar samples of fresh water, the amphoteric polymer coagulant of Example 2 was added in varying amounts along with a metal salt based coagulant, namely aluminum sulfate. The aluminum sulfate of Example 2 was obtained from a commercially available source. The amount of aluminum sulfate remained constant with respect to each of the sample jars. The aluminum sulfate was added in an amount of 45 ppm.

In comparison, varying amounts of a commercially available polyDADMAC were added to separate jar samples of fresh water of Example 2. In addition, a commercially available source of aluminum sulfate was added to each of these jar samples in an amount of 45 ppm.

### RESULTS 2

TABLE IIA

| Amount of Polyamphoteric | Amount of Aluminum Sulfate | Turbidity |
|---|---|---|
| Polymer (ppm) | (ppm) | (NTU) |
| 0.5 | 45 | 0.75 |
| 1.0 | 45 | 0.70 |
| 1.5 | 45 | 0.60 |

TABLE IIB

| Amount of polyDADMAC | Amount of Aluminum Sulfate | Turbidity |
|---|---|---|
| Polymer (ppm) | (ppm) | (NTU) |
| 1.0 | 45 | 0.90 |
| 1.5 | 45 | 0.80 |
| 2.0 | 45 | 0.55 |

As indicated in Table IIA, the amphoteric polymer coagulant used in combination with the aluminum sulfate of Example 2 can be effectively used to reduce or remove turbidity from a raw water source, namely, the fresh water source of Example 2. As further indicated in Table IIA, the turbidity was effectively reduced by adding increasing amounts of the amphoteric polymer coagulant of Example 2 to the raw water. These amounts ranged from 0.5 ppm to 1.5 ppm.

Further, the amphoteric polymer coagulant and aluminum sulfate coagulant (Table IIA) reduced or removed the turbidity at lower dosages as compared to the polyDADMAC coagulant and aluminum sulfate coagulant combination (Table IIB). The reduction of turbidity at 1 ppm of the amphoteric polymer coagulant was roughly equivalent to the same reduction level at 1.75 ppm of the polyDADMAC as product.

Based on a replacement ratio calculation, the test results of Example 2 indicate that the amphoteric polymer coagulant is more efficient than the polyDADMAC coagulant to remove turbidity from the fresh water source. The replacement ratio is a quantitative measure of the relative polymer efficiency at a given turbidity level with respect to a control polymer. The replacement ratio is calculated by dividing the amount of test polymer product by the amount of control polymer at the given turbidity level. In this case, the test polymer and control polymer are the amphoteric polymer and polyDADMAC polymer, respectively. At an approximate turbidity level of 0.70 NTU, the added amount of amphoteric polymer is 1 ppm in comparison to approximately 1.75 ppm of the polyDADMAC. Therefore, the replacement ratio, that is, the ratio of the dose of amphoteric polymer product to the dose of polyDADMAC polymer product at this turbidity level is 0.57.

The replacement ratio equates to about 0.57 as product (or 0.71 as polymer actives). This calculation takes into account that the amphoteric polymer has a concentration of 25% actives as compared to the polyDADMAC polymer, which has a concentration of 20% actives.

### EXAMPLE 3

Jar samples of a raw water source from a different Water Treatment Facility in the same Western State were obtained and evaluated in Example 3. The effects of treating the raw water sample with a polyamphoteric polymer coagulant in combination with a metal salt based coagulant in comparison to treatment of raw water with a polyDADMAC polymer coagulant in combination with a metal salt based coagulant were evaluated in Example 3. The amphoteric polymer coagulant was the same as that used in Examples 1 and 2 as previously discussed. The polyDADMAC and metal salt based coagulants, namely aluminum sulfate, were obtained from commercially available sources. The amount of polyamphoteric polymer coagulant and polyDADMAC coagulants added to separate jar samples of raw water was 0.6 ppm and 1.0 ppm, respectively, as indicated in Table III. The amount of aluminum sulfate added in combination with each of these coagulants was 23 ppm.

### RESULT 3

TABLE III

| | Amount of | Amount of | |
|---|---|---|---|
| Type of Polymer | Polymer Coagulant | Aluminum Sulfate | Turbidity |
| Coagulant | (ppm) | (ppm) | (NTU) |
| Polyamphoteric | 0.6 | 23 | 1.29 |
| PolyDADMAC | 1.0 | 23 | 1.80 |

As indicated in Table III, the polyamphoteric polymer coagulant outperformed the polyDADMAC coagulant. The turbidity level was lower at a lower dosage of the polyamphoteric polymer coagulant than that of the polyDADMAC at a higher dosage.

Because these results indicate that lower dosages of the polyamphoteric polymer coagulant can be effectively used to treat raw water, a cost savings can be realized if the polyamphoteric polymer coagulant is used instead of the polyDADMAC coagulant. Based on an estimate of current costs generally associated with each of these types of coagulants, the estimated costs associated with using the polyamphoteric polymer coagulant of Example 3 to treat raw water is $7.76/milliongallons of raw water (abbreviated “MG”) as compared to $8.26/MG for the polyDADMAC coagulant. The replacement ratio can also be estimated at 0.6 based on replacement ratio calculations as previously discussed.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

We claim:

1. A method of treating raw water comprising: adding an amphoteric polymer coagulant and optionally at least one metal salt coagulant to the raw water.

2. The method of claim 1 wherein said amphoteric polymer coagulant is a copolymer comprising acrylic acid and an amine acrylate.

3. The method of claim 2 wherein said amine acrylate is selected from the group consisting of dimethylaminoethyl acrylate, dimethylaminoethyl acrylate methyl chloride quat, dimethylaminoethyl acrylate benzyl chloride quat, dimethylaminoethyl methacrylate, dimethylaminoethyl methacrylate methyl chloride quat, dimethylaminoethyl methacrylate benzyl chloride quat, dimethylaminoethyl methacrylate sulfuric acid salt, N-((3-dimethylamino)-propyl)methacrylamide and 3-(methacryloylamino-propyl)trimethyl ammonium chloride.

4. The method of claim 1 wherein a metal salt coagulant is used and said metal salt coagulant is selected from the group consisting of aluminum sulfates, polyaluminum chlorides, including aluminum chlorohydrate, ferric salts, ferrous salts, and other similar metal salt based coagulants, and mixtures thereof.

5. The method of claim 2 wherein said amphoteric polymer coagulant has a molar ratio of amine acrylate to acrylic acid ranging from about 99:1 to about 1:99.

6. The method of claim 5 wherein said molar ratio ranges from about 90:10 to about 70:30.

7. The method of claim 1 wherein said amphoteric polymer coagulant is added in an amount of at least about 0.25 ppm.

8. The method of claim 1 wherein said amphoteric polymer coagulant is added in an amount ranging from greater than about 0.25 ppm to about 6 ppm.

9. The method of claim 1 wherein said amphoteric polymer coagulant is added in an amount ranging from about 0.5 ppm to about 5 ppm.

10. The method of claim 1 wherein said metal salt coagulant is used and is added in an amount of at least about 23 ppm.

11. The method of claim 1 further comprising the step of clarifying the raw water.

12. The method of claim 11 wherein said raw water is clarified by reducing turbidity.

13. The method of claim 11 wherein said raw water is clarified by removing color.

14. The method of claim 1 wherein said metal salt coagulant is aluminum sulfate.

15. The method of claim 1 wherein said raw water is associated with a drinking water treatment process.

16. The method of claim 1 wherein said raw water is associated with a paper mill process.

17. The method of claim 1 wherein said raw water is to be used as a drinking water source.

18. The method of claim 1 wherein said amphoteric polymer coagulant and optionally said metal salt based coagulant are added to said raw water prior to sedimentation unit operation.

19. The method of claim 1 wherein said amphoteric polymer coagulant and optionally said metal salt based coagulant are added to said raw water after a sedimentation unit operation.
